(19) United States
(12) Patent Application Publication
(10) Pub. No.: US 2010/0246200 A1
(43) Pub. Date: Sep. 30, 2010

(54) AUTOMOTIVE TAILLIGHT LIGHT GUIDE

(75) Inventors: THOMAS TESSNOW, WEARE, NH (US); MICHAEL TUCKER, HENNIKER, NH (US)

Correspondence Address: OSRAM SYLVANIA INC, 100 ENDICOTT STREET, DANVERS, MA, 01923, US

(73) Assignee: OSRAM SYLVANIA Inc., DANVERS, MA (US)

(21) Appl. No.: 12/414,093

(22) Filed: Mar. 30, 2009

(51) Int. Cl. F21V 1/00

(52) U.S. Cl. 362/509

(57) ABSTRACT

A light guide for an automotive tail light may be efficiently made with a plurality of thick planar light guides stacked side by side to have a common input source point at one end, but spread at their respective opposite ends to be arranged to form parallel planes separated sufficiently to project a relatively larger combined image that may suggest in outline a larger object. The relatively thick plates efficiently transmit light. The planar structures direct light efficiently in the horizontal plane. The side by side offset of the output windows creates an image of a larger more readily seen structure.

### CROSS-REFERENCE TO RELATED APPLICATIONS

Not applicable

### BACKGROUND OF THE INVENTION

1. Field of the Invention

The invention relates to electric lamps and particularly to automotive electric lamps. More particularly the invention is concerned with automotive taillamps with LED light sources and light guides.

2. Description of the Related Art Including Information Disclosed Under 37 CFR 1.97 and 1.98

Light production in an LED is concentrated in a tiny volume. Directly viewing a nearly point source of emitted light is uncomfortable. Human response studies have found response times are faster when sensing a change in a large image as opposed to a small image. There is then a general need to both spread the emitted light from LED taillight source in all the required directions, and to do so while forming a conveniently large image, one not so small as to be offensively intense, one sufficiently large to invoke a rapid response and yet one not so large as to be unnecessarily expensive. Reflectors are commonly used to spread light from filament sources, but they are generally deep and wide, requiring large reflective areas. Light guides are commonly used to spread or diffuse light away from LED sources. Typical taillight designs used in automotive lamps have used flexible fiber optics with a lens at the end of each fiber, or solid body light guides with features to direct light perpendicular to the light guide axis. Fiber optics are hard to assembly into practical devices. Fiber units can also be difficult to optically point correctly. On the other hand, solid light guides with features to direct light perpendicular to the light guide axis are generally inefficient and leave gaps between the directing features. Increasing the number of directing features and making them small increases the tooling and manufacturing costs. There is then a need for an automotive LED light distributing method that is accurate, large in area and still inexpensive.

### BRIEF SUMMARY OF THE INVENTION

An automotive taillight light guide for receiving light from a light source with a minimal beam width and a corresponding maximal beam angle. The light guide may be made from a plurality of light transmissive plates. Each plate has a first broad side and a second broad side joined by a narrow circumferential edge. The first broad side and the second broad side are separated by an approximately constant thickness. The broad sides have lengths and widths ten or more times greater than the thickness. An input window formed along the edge receives light from an LED light source. The input window has a central normal that serves to define an input axis. An output window is formed along the edge comprising a plurality of light intercepting faces directing light to a field to be illuminated. The light guide includes at least one plate that extends from the input window toward the output window as a first planar portion extending along a first plane including the input axis, the plate then bends away from such first planar portion and then bends back to extend in a second planar portion along a second plane that is substantially parallel to the input axis but is offset from the input axis.

### BRIEF DESCRIPTION OF THE SEVERAL VIEWS OF THE DRAWINGS

FIG. 1 shows a front perspective view of a preferred embodiment of an automotive light guide and LED light source.

FIG. 2 shows a rear perspective view of two sections of the automotive light guide of FIG. 1.

FIG. 3 shows an end perspective view of one section of the automotive light guide and LED light source of FIG. 1.

FIG. 4 shows a front perspective view of a preferred embodiment of an automotive light guide.

FIG. 5 shows a front perspective view of the automotive LED light source of FIGS. 1 and 3.

FIG. 6 shows a perspective view of a preferred embodiment of an automotive light guide mounted in an automotive rear light housing.

### DETAILED DESCRIPTION OF THE INVENTION

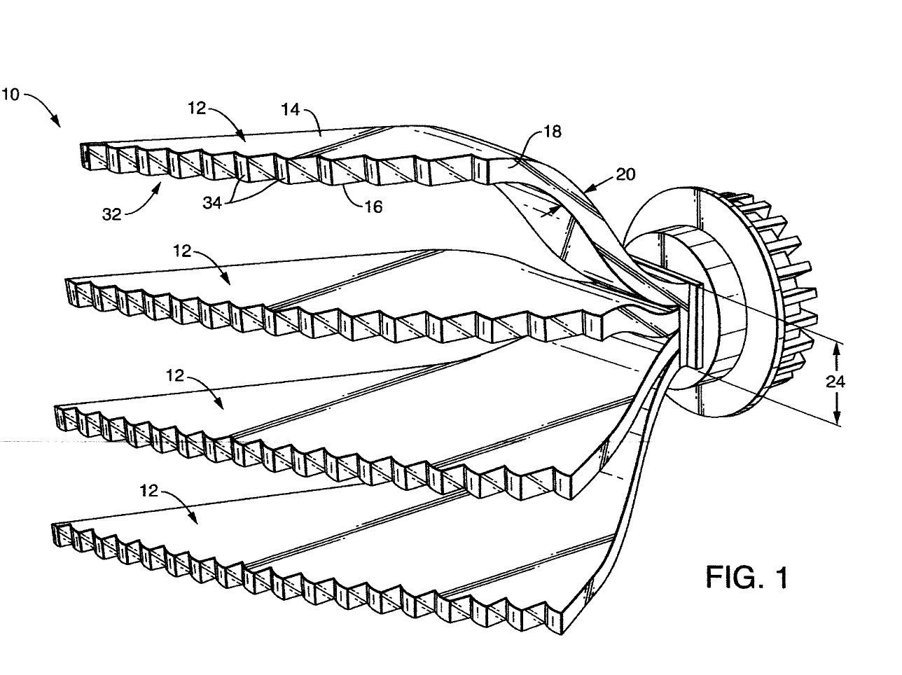

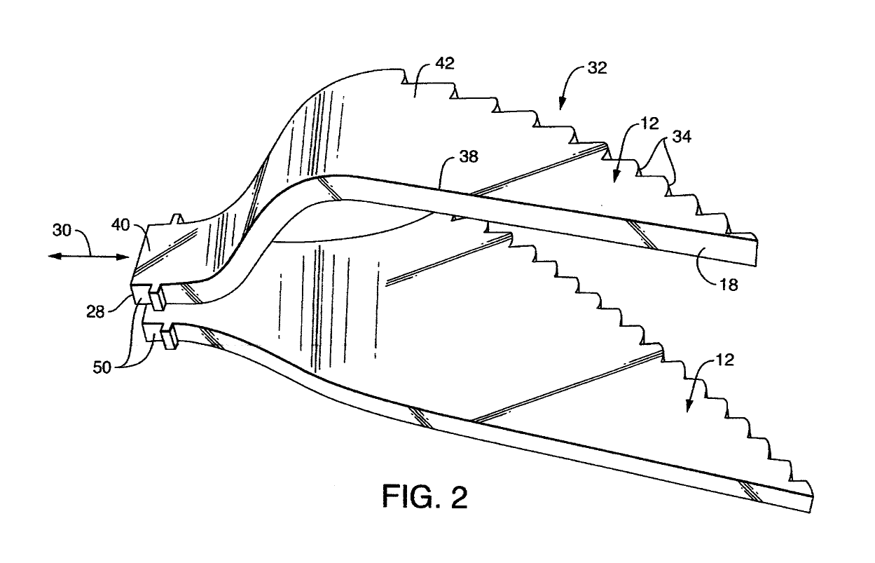

FIG. 1 shows a front perspective view of a preferred embodiment of an automotive light guide 10 and LED light source. FIG. 2 shows a rear perspective view of two plate sections of the automotive light guide of FIG. 1. The automotive taillight light guide 10 is formed from a plurality of light transmissive plates 12. The number of plates 12 preferred by the Applicant varies from two to four, but ten or more plates 12 are expected to still be practical. Each plate 12 has a first broad side 14 and a second broad side 16 that are joined by a narrow circumferential edge 18. The first broad side 14 and the second broad side 16 are each locally substantially flat and separated by an approximately constant thickness 20 thereby providing a substantially totally internally reflective light guide. The thickness 20 should be at least as large as the least transverse dimension 22 (=W) of the input light beam received from a light source 26. Preferably, the thickness 20 should be sufficiently greater than the least beam width to allow a typical internal refection angle of the beam that is much less than 45 degrees. The transiting light should preferably be made up of long straight segments with only a few, small (glancing) angle reflections, and few if any, large angle reflections. A thickness 20 that is two more times the minimal beam 22 width is preferred. A planar input window 28 for receiving light is formed along the edge 18. The central normal to the input window 28 defines an input axis 30. In particular, the combined input window 28 thicknesses 20 (=T) for receiving light should be equal to or greater than the minimal light source 26 beam width W, and the combined input window should be offset from the light source 26 by less than a spacing S such that the difference between the combined plate thicknesses 20 forming the combined (common) window thickness 24 (=T) and the beam 27 width W divided by two times the spacing S is greater than the sine of one half the light source beam angle A, that is (T−W)/2S>sin(λ/2).

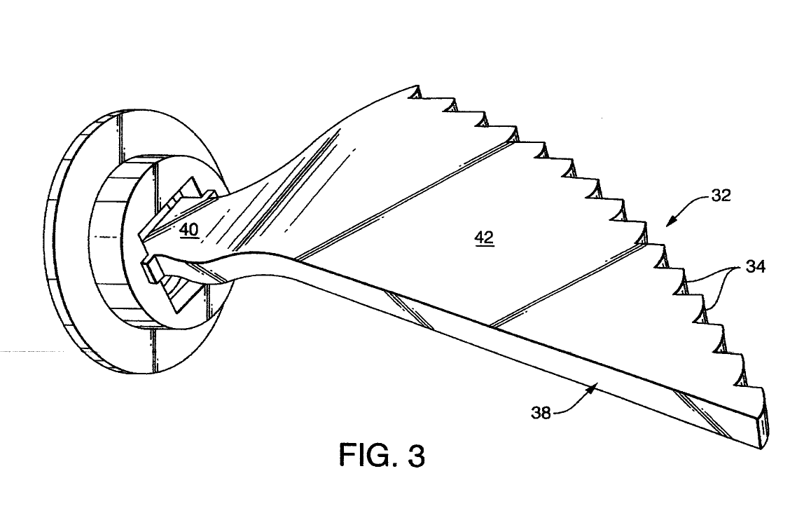

An output window 32 is formed also along the edge 18, generally along the opposite end of the light guide from where the input window 28 is positioned. The preferred output window 32 comprises a plurality of light intercepting faces 34 directing light to a field to be illuminated. For example, the output window 32 may have a saw tooth pattern, preferable with one face of each tooth being parallel to the input axis 30 and one face of each tooth being at an angle (not being parallel) to the input axis 30. The saw tooth pattern may be more specifically a staircase pattern, where the steps are approximately perpendicular to the input axis 30 and the risers are approximately parallel to the input axis 30. The steps may be formed with pillow optics to evenly spread the exiting light. Other output window 32 formations may be used, such as sandblasting a section of the edge 18 or forming side facing (not staircased) pillow or similar optics on the circumferential edge 18. It is only necessary that the light supplied through the input window 28 to the light guide be intercepted and refracted along the output window 32 that is along the front edge 18 to be directed toward the field to be illuminated. FIG. 3 shows an end perspective view of one section of the automotive light guide and LED light source of FIG. 1. A back side 38 is also formed along the circumferential edge 18. The preferred back side 38 extends substantially in a plane parallel to the input axis 30, and is formed to be internally reflective so as to lose little or none of the light transmitted into the light guide at the input window 28.

At least one of the plates 12 extending from the input window 28 toward the output window 32 has a first planar portion 40. The first planar portion 40 extends along a first plane including the input axis 30. The plate 12 is then gently curved or bent away from such first plane so as to not lose light and is then gently curved or bent back, again to not lose light, to extend in a second planar portion 42. The second planar portion 42 is generally along a second plane that parallels the input axis 30 but is offset from the input axis 30. The plate 12 then forms a gentle S curve bending from the first planar portion 40 to extend in the second planar portion 42. The plate 12 then gently guides light received into the first planar portion 40 to the second planar portion 42, where the light is transmitted out, the output window 32. The planar offset from the first planar portion to the second planar portion may vary from plate to plate but would typically be at least as large as the plate thickness, perhaps as much at ten or more times the plate thickness. The preferred back side 38 extends along the second planar portion 42 as a straight section parallel to the input axis 30.

The preferred output window 32 extends along a front side of the second planar portion 42. The front side with the output window 32 curves around toward the back side 38 or extends substantially as a straight line (may be staircased) at an angle to the input axis 30 aimed to intercept the back side 38. In either case, the output window 32 extends to across a direction line pointing to the field to be illuminated to intercept the back side 38.

In the preferred embodiment, there is a plurality of such plates 12 that are roughly similarly in form. The plates 12 are arrayed in parallel, so the respective broad sides 14, 16 of the second planar portions 42 are parallel thereby forming offset slices through a three dimensional space. Preferably these offset slices are spaced apart by three or more times the thickness of the plate 42. The respectively more exterior plates 12 (those at the top of the stack or those at the bottom of the stack) may have relatively more bend to their respective S curves. The respective plates 12 may having differing widths or lengths to the respective second planar portion 42 to thereby suggest in outline a common intercepted surface (imaginary). The plurality of output windows 32 then appear widely spread but as parallel slices through the defined or suggested commonly intercepted surface (imaginary). Each slice being defined by a respective coplanar second planar portion 42. In the preferred embodiment, the respective second planar portions 42 are offset one from the other by an equal amount. The offset output windows expand the optical image, and create or simulate a larger illuminated region that is more easily responded to mentally by a viewer.

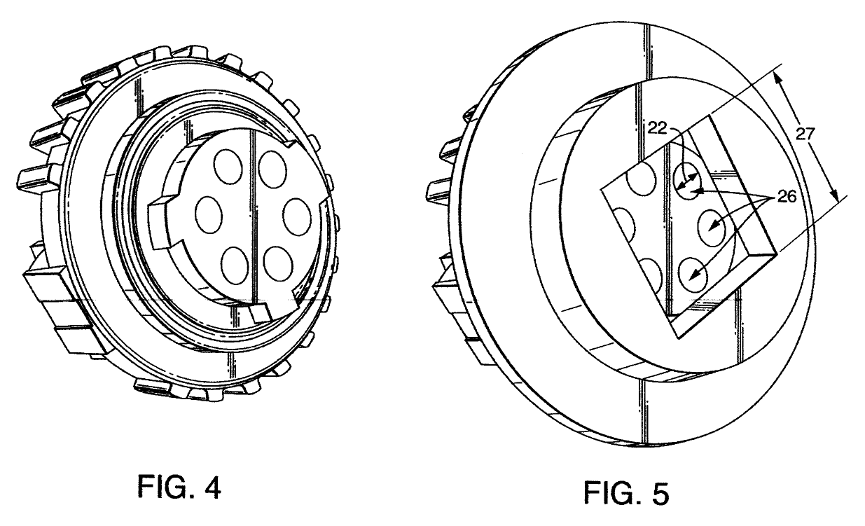

In the preferred embodiment, the respective input windows 28 are arranged side by side to form a common input window 28 facing a common light source or sources. The respective input windows 28 may be joined (strapped, glued, clamped, or similarly coupled) as a group, thereby aligning, joining or trapping the respective sides 50 (edge 18 portions) adjacent the respective input windows 28 with or in a socket 52. The socket 52 may then pin the input ends 50 of the plates 12 as a group. Of course, the plates 12 may otherwise be grouped as a unit along the input window 28 face area. The aligned input window faces 28 then, as a group have or define a common input face that may be optically coupled or pressed to an adjacent a light source 26; such as an LED array, or similar light source 26 as an input. FIG. 4 shows a front perspective view of a preferred embodiment of an automotive light guide. FIG. 5 shows a front perspective view of the automotive LED light source of FIGS. 1 and 3. By aligning each plate 12 with a separated row of LEDs, the stack of differing plates 12 may be illuminated separately or jointly.

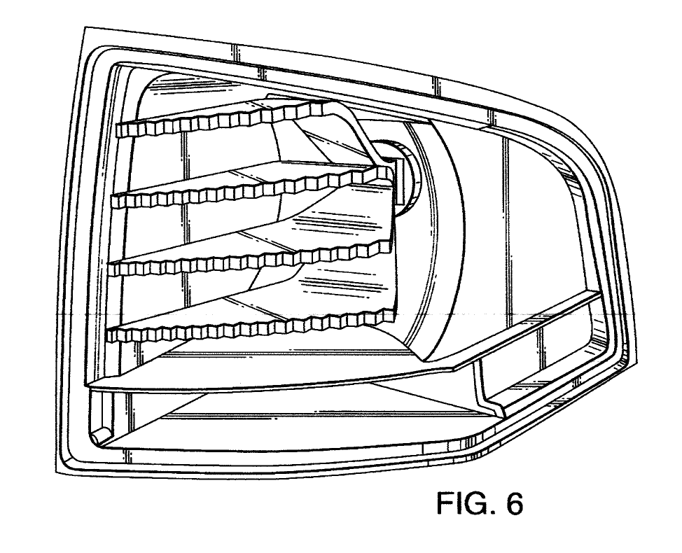

FIG. 6 shows a perspective view of a preferred embodiment of an automotive light guide mounted in an automotive rear light housing. The stack of a relatively few number of light guides having modestly large thicknesses 20 and long output windows 32 efficiently captured the input light and accurately spread it horizontally to the field to be illuminated from a visually large (spread) source 26 that was comfortable to view. The tail light optic was then efficient, and visually effective and not offensive. In one embodiment four transparent plastic plates (sheets) about 5 mm. thick with a narrow light input end were arrayed in a vertical stack. The top and bottom sheets were bent out of plane and then back into parallel planes with maximum angles of up to about 25 degrees. The output ends were generally sculpted as a group to follow (mimic) the exterior curvature of the vehicle. The window output ends had pillow optics to create a horizontally spread beam pattern. The emission pattern from the plates was already collimated with an emission angle of plus or minus 30 degrees from the input axis. No focusing optics were needed. Pillow optics spread the pattern horizontally to create visibility at wider angles. Losses were small as the beam from the LED source was already collimated. The total internal reflection angle of the guide was about 45 degrees, while the source had a spread of plus or minus 30 degrees in air (plus or minus 20 degrees in the optic) which gave the optic about 20 degrees of head room for loss. Even though the planar bends were more than 25 degrees, the losses were less than with a lambertian (hemispherical) emission pattern.

While there have been shown and described what are at present considered to be the preferred embodiments of the invention, it will be apparent to those skilled in the art that various changes and modifications can be made herein without departing from the scope of the invention defined by the appended claims.

What is claimed is:

1. An automotive taillight light guide for receiving light from a light source with a minimal beam width of W and a corresponding maximal beam angle of A, the light guide comprising:
a plurality of light transmissive plates, each plate having
a first broad side and a second broad side joined by a narrow circumferential edge, the first broad side and the second broad side being separated by an approximately constant thickness; the first broad side having a length and width ten or more times greater than the thickness;
an input window for receiving light, the input window formed along the edge, the central normal of the input window defining an input axis;
an output window formed along the edge comprising a plurality of light deflecting features intercepting light passing in the light guide and directing such light to a field to be illuminated;
at least one plate extending from the input window toward the output window along a first planar portion along a first plane including the input axis, the plate then bending away from such first plane and then bending back to extend in a second planar portion along a second plane that is substantially parallel to the input axis but is offset from the input axis.

2. The automotive taillight in claim 1, wherein the input window has the combined input window thicknesses being equal to or greater than W, and the combined windows being offset from the light source by less than an amount S such that the difference between the plate thickness and the beam width divided by the spacing is greater than the sine of the source beam angle.

3. An automotive taillight light guide comprising:
a plurality of light transmissive plates, each plate having
a first broad side and a second broad side joined by a narrow circumferential edge, the first broad side and the second broad side being separated by an approximately constant thickness;
an input window for receiving light formed along the edge, the central normal of the input window defining an input axis;
an output window formed along the edge comprising a plurality of light deflecting features directing intercepting light passing in the guide to a field to be illuminated;
at least one plate extending from the input window toward the output window along a first planar portion along a first plane including the input axis, the plate then bending away from such first plane and then bending back to extend in a second planar portion along a second plane that is substantially parallel to the input axis but is offset from the input axis.

4. The automotive taillight light guide in claim 1, further having a back side formed along the edge, the back side extending in the second planar portion, substantially parallel to the input axis.

5. The automotive taillight light guide in claim 1, wherein the output window extends along a front side of the second planar portion, the front side extending substantially at an angle to the input axis to intercept the back side.

6. The automotive taillight light guide in claim 1, having a plurality of plates with respective coplanar first planar portions, and respective coplanar second planar portions, the respective second planar portions being offset one from the other by air gaps.

7. The automotive taillight light guide in claim 1, having a plurality of said plates with coplanar second planar portions, the respective second planar portions being offset equally one from the other.

8. The automotive taillight light guide in claim 7, wherein the respective second planar portions are offset by three or more times the thickness of the planar portion.

9. The automotive taillight light guide in claim 1, having a plurality of said plates wherein the respective input windows are arranged side by side to form a common input window.

10. The automotive taillight light guide in claim 1, having a plurality of said plates arranged with the respective input windows to be side by side to form a common input window, said plates joined as a group along the respective sides adjacent the respective input windows in a socket formed adjacent a light source.

11. The automotive taillight light guide in claim 1, wherein the output window is arranged in a staircase pattern, with steps being generally perpendicular to the input axis and the risers being generally parallel to the input axis.

12. The automotive taillight light guide in claim 1, wherein the output window is arranged in a saw tooth pattern, with a first edge of each respective tooth section generally parallel to the input axis and a second edge of each respective tooth section being generally not parallel to the input axis.

13. An automotive taillight light guide comprising:
a plurality of light transmissive plates, each plate having
a first broad side and a second broad side joined by a narrow circumferential edge, the first broad side and the second broad side being separated by an approximately constant thickness;
a planar input window for receiving light formed along the edge, the normal to the input window defining an input axis,
an output window formed along the edge, the output window including a plurality of light deflecting features positioned to intercept and directing light passing in the guide to a field to be illuminated; the output window extending along a front side of the second planar portion, the front side extending substantially at an angle to the input axis to intercept the back side;
a back side formed along the edge, the back side extending substantially parallel to the input axis;
at least one plate extending from the input window toward the output window in a first planar portion along a first plane including the input axis, then bending away from such first plane and then bending back to extend in a second planar portion along a second plane parallel to the input axis but offset from the input axis;
the back side extending along the second planar portion;
the plurality of plates each having parallel second planar portions, the respective second planar portions being offset one from the other by an equal amount;
the respective input windows being arranged side by side to form a common input window; and
the respective input windows joined as a group along the respective sides adjacent the respective input windows in a socket formed adjacent a light source.
